(19) United States
(12) Patent Application Publication
(10) Pub. No.: US 2007/0007261 A1
(43) Pub. Date: Jan. 11, 2007

(54) Welding method for golf club head

(75) Inventor: Wen-Ching Hou, Kaohsiung (TW)

Correspondence Address: BIRCH STEWART KOLASCH & BIRCH, PO BOX 747, FALLS CHURCH, VA, 22040-0747, US

(73) Assignee: NELSON PRECISION CASTING CO., LTD.

(21) Appl. No.: 11/176,267

(22) Filed: Jul. 8, 2005

(51) Int. Cl. B23K 35/24; B23K 26/00; B23K 20/16

(52) U.S. Cl. 219/121.64; 228/262.51

(57) ABSTRACT

A welding method for a golf club head includes preparing a first club head part made of Fe—Mn—Al alloy, preparing a second club head part made of an alloy having a melting point higher than that of the Fe—Mn—Al alloy, and bonding the first club head part and the second club head part together by high energy welding having an energy density substantially greater than 10⁶ W/mm², thereby causing momentary synchronous melting and secure welding bonding of the first club head part and the second club head part. The high energy welding may be laser welding or electronic beam welding.

### BACKGROUND OF THE INVENTION

1. Field of the Invention

The present invention relates to a welding method. In particular, the present invention relates to a welding method for a golf club head.

2. Description of Related Art

U.S. Pat. No. 6,617,050 (Taiwan Patent Publication No. 460591) discloses low density and high ductility alloy steel for a golf club head, wherein Fe—Mn—Al alloy is selected to manufacture a golf club head by precision lost-wax casting or forging. The resultant golf club head has high strength, low density, high ductility, high corrosion resistance, and excellent surface properties, as the Fe—Mn—Al alloy has excellent properties in corrosion resistance, forging processing, surface properties, ductility, and tensile strength.

However, the Fe—Mn—Al alloy could not be used to manufacture a golf club head comprised of a plurality of parts. This is because the Fe—Mn—Al alloy could not be securely engaged with other metals by welding. In particular, when bonding the Fe—Mn—Al alloy with a different metal by welding, it is difficult to simultaneously melt the Fe—Mn—Al alloy and the metal at the contact area therebetween. Undesired over melting and depression of the Fe—Mn—Al alloy occur, leading to unreliable welding and unsatisfactory qualified product ratio. Application of the Fe—Mn—Al alloy in the welding of a golf club head comprised of a plurality of parts is thus limited.

### OBJECTS OF THE INVENTION

An object of the present invention is to provide a welding method for a golf club head to improve the welding reliability.

Another object of the present invention is to provide a welding method for a golf club head to improve the qualified product ratio.

### SUMMARY OF THE INVENTION

In accordance with an aspect of the present invention, a welding method for a golf club head comprises preparing a first club head part made of Fe—Mn—Al alloy, preparing a second club head part made of an alloy having a melting point higher than that of the Fe—Mn—Al alloy, and bonding the first club head part and the second club head part together by high energy welding having an energy density substantially greater than 10⁶ W/mm², thereby causing momentary synchronous melting and secure welding bonding of the first club head part and the second club head part.

Preferably, the alloy for the second club head part is selected from a group consisting of stainless steel, carbon steel, low-carbon steel, alloy steel, low-alloy steel, maraging steel, martensite steel, cast iron, structural steel, and W—Fe—Ni alloy.

Preferably, the high energy welding is laser welding or electronic beam welding having an energy density greater than 10⁷ W/mm².

In an example of the invention, the first club head part is a body of a golf club head.

Preferably, the body comprises an assembling opening in a front side thereof for engaging with the second club head part.

Preferably, the body comprises a stepped portion extending inward from an inner perimeter delimiting the assembling opening, and the second club head part is engaged with the stepped portion.

Preferably, the assembling opening comprises a main engaging lip and a side engaging lip for engaging with the second club head part.

In another example of the invention, the first club head part is a striking plate.

Preferably, the striking plate comprises a perimeter wall to form a substantially U-shaped structure for improving elastomeric deforming capability.

Preferably, the striking plate further comprises an open side. Each of the perimeter wall and the open side has an end face engaged with the assembling opening.

In a further example of the invention, the first club head part is a cover plate.

Preferably, the cover plate is a crown plate, sole plate, or side plate.

In still another example of the invention, the first club head part is a weight member.

In an example of the invention, the second club head part is a body of a golf club head.

Preferably, the body comprises an assembling opening in a front side thereof for engaging with the first club head part.

Preferably, the body comprises a stepped portion extending inward from an inner perimeter delimiting the assembling opening, and the first club head part is engaged with the stepped portion.

Preferably, the assembling opening comprises a main engaging lip and a side engaging lip for engaging with the first club head part.

In another example of the invention, the second club head part is a striking plate.

Preferably, the striking plate comprises a perimeter wall to form a substantially U-shaped structure for improving elastomeric deforming capability.

Preferably, the striking plate further comprises an open side. Each of the perimeter wall and the open side has an end face engaged with the assembling opening.

In a further example of the invention, the second club head part is a cover plate.

Preferably, the cover plate is a crown plate, sole plate, or side plate.

In still another example of the invention, the second club head part is a weight member.

Other objects, advantages and novel features of this invention will become more apparent from the following detailed description when taken in conjunction with the accompanying drawings.

### BRIEF DESCRIPTION OF THE DRAWINGS

FIG. 1 is a block diagram illustrating a welding method for a golf club head in accordance with the present invention;

FIG. 2 is an exploded perspective view of an example of a golf club head using the welding method in accordance with the present invention;

FIG. 3A is an enlarged sectional view of the golf club head in FIG. 2 before welding;

FIG. 3B is a sectional view similar to FIG. 2, illustrating plasma welding or tungsten inert gas arc welding;

FIG. 3C is a sectional view similar to FIG. 2, illustrating laser welding or electronic beam welding;

FIG. 4 is an exploded perspective view of another example of the golf club head using the welding method in accordance with the present invention; and

FIG. 5 is an exploded perspective view of another example of the golf club head using the welding method in accordance with the present invention.

### DETAILED DESCRIPTION OF THE PREFERRED EMBODIMENTS

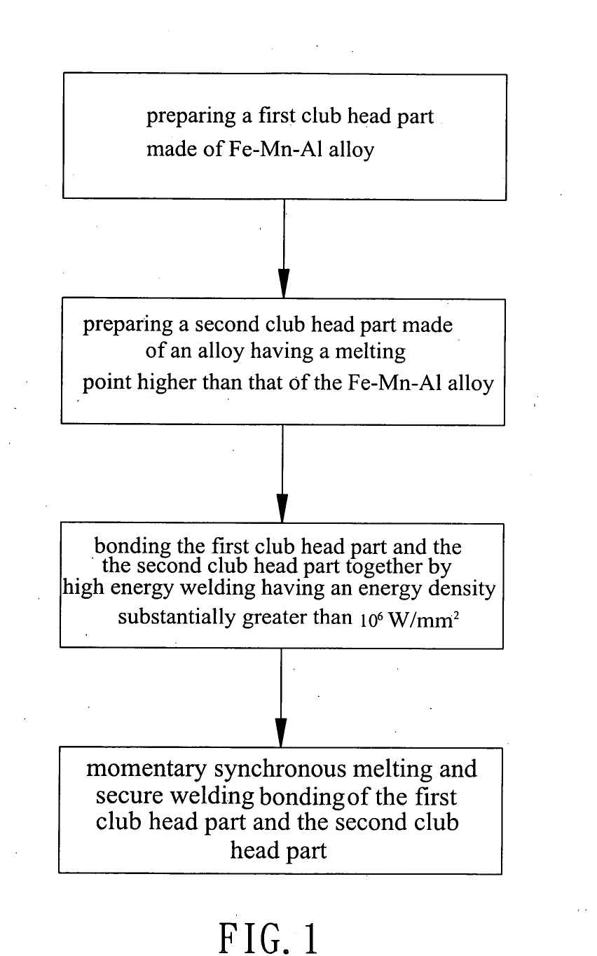

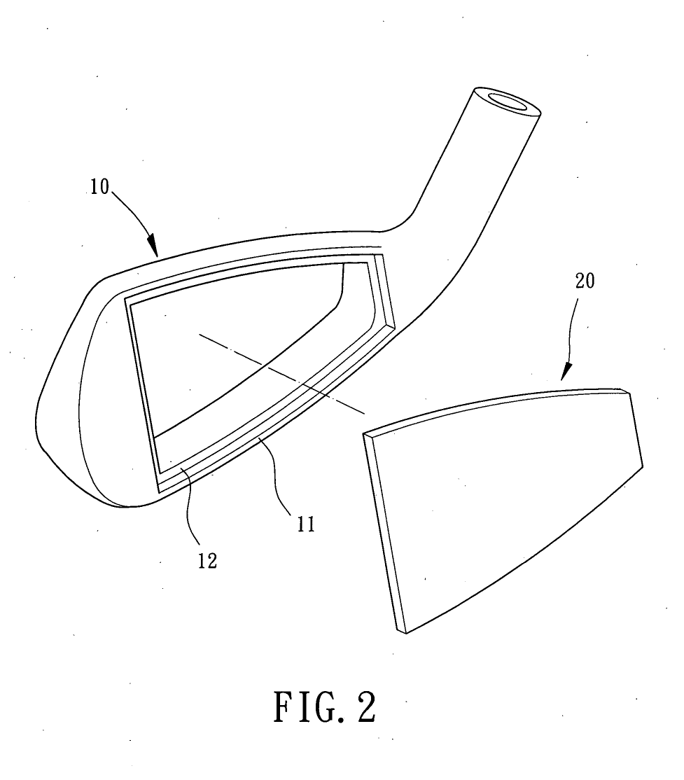

Referring to FIGS. 1 and 2, a welding method for a golf club head in accordance with the present invention comprises preparing a first club head part 10 made of Fe—Mn—Al alloy, preparing a second club head part 20 made of an alloy having a melting point higher than that of the Fe—Mn—Al alloy, bonding the first club head part 10 and the second club head part 20 together by high energy welding having an energy density substantially greater than 10⁶ W/mm², thereby causing momentary synchronous melting and secure welding bonding of the first club head part 10 and the second club head part 20.

The golf club head illustrated in FIG. 2 is of iron type. The first club head part 10 is a body having an assembling opening 11 in a front side thereof, with a stepped portion 12 extending inward from an inner perimeter delimiting the assembling opening 11. Alternatively, the first club head part 10 is a striking plate. The Fe—Mn—Al alloy has a melting point of about 1050-1150° C. and a specific gravity of about 6.5-7.5.

The second club head part 20 is made of an alloy having a melting point higher than that of the Fe—Mn—Al alloy, as mentioned above. The second club head part 20 may be a striking plate (or body) of a golf club head. The alloy for the second club head part 20 is preferably selected from a group consisting of stainless steel, carbon steel, low-carbon steel, alloy steel, low-alloy steel, maraging steel, martensite steel, cast iron, and structural steel and the alloy for the second club head part 20 has a melting point of about 1250-1450° C. and a specific gravity of about 8.0-10.0. Hence, there is a difference in temperature between two melting points of the first club head part 10 and the second club head part 20 substantially greater than 100° C.

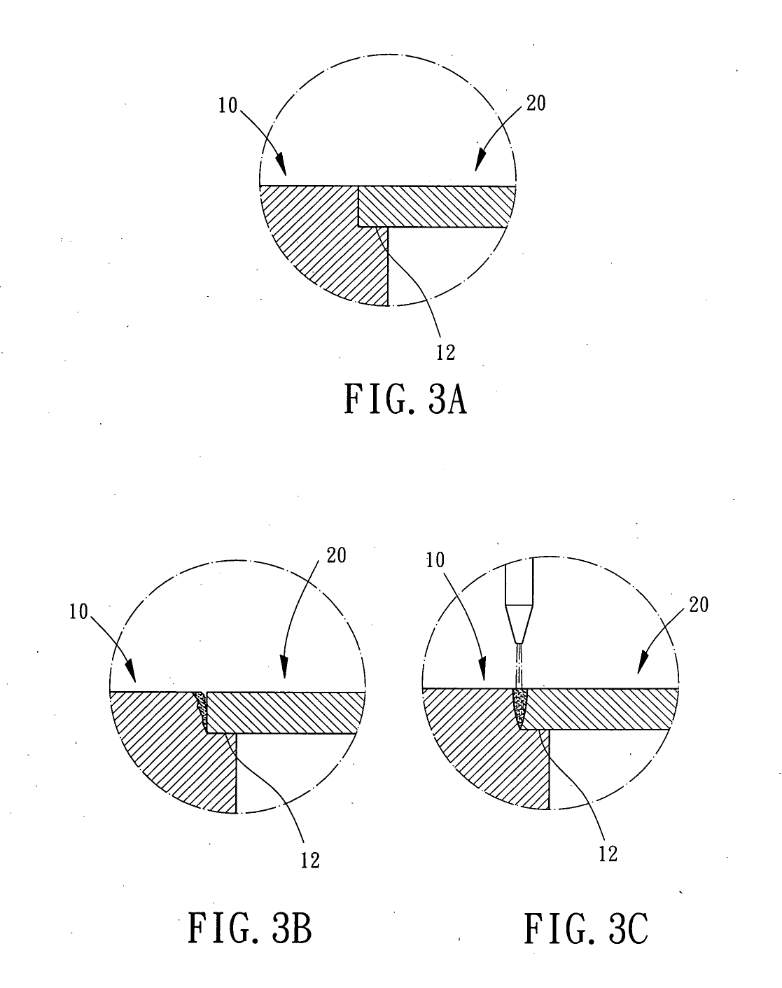

FIG. 3A is an enlarged sectional view of the golf club head in FIG. 2 before welding. The second club head part 20 (striking plate) is placed on the stepped portion 12 of the assembling opening 11 of the first club head part 10. In this example, the melting point of the Fe—Mn—Al alloy for the first club head part 10 is about 1100° C. whereas the second club head part 20 is made of stainless steel having a melting point of about 1300-1400° C.

As mentioned above, the high energy welding for bonding the first club head part 10 and the second club head part 20 together has an energy density substantially greater than 10⁶ W/mm². Referring to FIG. 3C, in an example of the invention, the first club head part 10 an the second club head part 20 were welded together by electronic beam welding having an energy density greater than 10⁷ W/mm². The engaging area between the first club head part 10 and the second club head part 20 melted momentarily and synchronously. Thus, undesired advanced melting (or over melting) and undesired depression in the Fe—Mn—Al alloy did not occur.

Thus, the first club head part 10 and the second club head part 20 can be reliably welded together by the welding method in accordance with the present invention. The welding reliability is improved and the qualified product ratio is increased. The high energy welding can be laser welding having an energy density greater than 10⁷ W/mm².

FIG. 3B shows a comparison example, wherein the first club head part 10 and the second club head part 20 were welded together by plasma welding having an energy density of about 10⁵ W/mm² or tungsten inert gas arc welding having an energy density of about 10³ W/mm². Since the energy density is low, the first club head part 10 made of Fe—Mn—Al alloy with a lower melting point melted in a first stage of welding whereas the second club head part 20 made of stainless steel with a higher melting point remained solid. Thus, the first club head part 10 made of Fe—Mn—Al alloy over melted when the second club head part 20 made of stainless steel began to melt, resulting in depression in the engaging portion of the first club head part 10. The qualified product ratio was thus adversely affected.

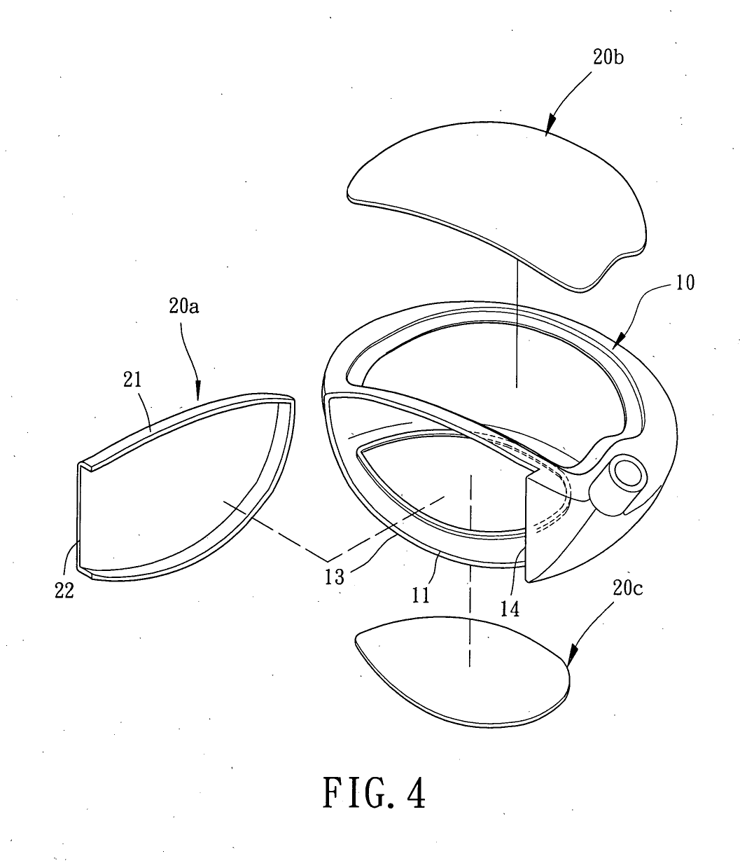

FIG. 4 is an exploded perspective view of another example of the golf club head using the welding method in accordance with the present invention. The golf club head in the illustrated embodiment is of wood type. It is noted that the welding method in accordance with the present invention can be used to manufacture a golf club head of other types, such as utility type or putter type.

The first club head part 10 is preferably a body having at least one assembling opening 10 that has a main engaging lip 13 and a side engaging lip 14. Alternatively, the first club head part 10 can be a cover plate such as a U-shaped striking plate, a crown plate, or a sole plate. At least one second golf club part 20a, 20b, 20c is provided and made of an alloy (such as stainless steel, carbon steel, low-carbon steel, alloy steel, low-alloy steel, maraging steel, martensite steel, cast iron, or structural steel) having a melting point higher than that of the Fe—Mn—Al alloy.

In the embodiment illustrated in FIG. 4, the second club head part 20a is a striking plate that is U-shaped in section. In particular, the striking plate 20a is bent rearward along a perimeter edge thereof, forming a perimeter wall 21 having an open side 22. The perimeter wall 21 improves the elastomeric deforming capability of the second club head part 20a. An end face of the perimeter wall 21 is engaged with the main engaging lip 13 of the assembling opening 11 whereas an end face of the open side 22 is engaged with the side engaging lip 14 of the assembling opening 1. Two further club head parts 20b and 20c are engaged with other assembling openings (not labeled) of the first club head part 10. Each club head part 20b, 20c may be a cover plate such as a crown plate, sole plate, or side plate. In an alternative example, one of the club head part 20b, 20c is a body of a golf club head.

In the welding procedure, high energy welding (such as laser welding or electronic beam welding) having an energy density substantially greater than 10⁶ W/mm² is carried out to momentarily and synchronously melt the engaging area between at least two of the club head parts 10, 20a, 20b, and 20c (see FIG. 3C). Undesired advanced melting (or over melting) and undesired depression in the Fe—Mn—Al alloy are avoided. Thus, at least two of the club head parts 10, 20a, 20b, and 20c can be reliably welded together by the welding method in accordance with the present invention. The welding reliability is improved and the qualified product ratio is increased.

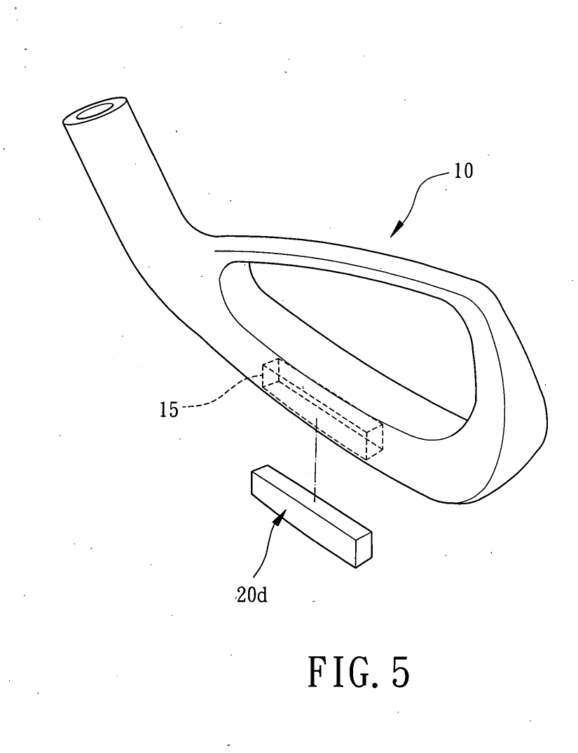

FIG. 5 is an exploded perspective view of another example of the golf club head using the welding method in accordance with the present invention.

The first club head part 10 is made of Fe—Mn—Al alloy. The first club head part 10 is a body having an assembling opening 11 in a bottom side thereof. Alternatively, the first club head part 10 is an accessory member for a golf club head, such as a weight member.

The second club head part 20 is made of an alloy (such as W—Fe—Ni alloy or other W—Fe alloy) having a melting point higher than that of the Fe—Mn—Al alloy. The second club head part 20 is an accessory member for a golf club head, such as a weight member. The second club head part 20 is engaged in the assembling opening 15 of the first club head part 10 (body) by any suitable method. Alternatively, the second club head part 20 is a body of a golf club head.

In the welding procedure, high energy welding (such as laser welding or electronic beam welding) having an energy density substantially greater than 10⁶ W/mm² is carried out to momentarily and synchronously melt the engaging area between the first club head part 10 and the second club head part 20 (see FIG. 3C). Undesired advanced melting (or over melting) and undesired depression in the Fe—Mn—Al alloy are avoided. Thus, the first club head part 10 and the second club head part 20 can be reliably welded together by the welding method in accordance with the present invention. The welding reliability is improved and the qualified product ratio is increased.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A welding method for a golf club head comprising:
preparing a first club head part made of Fe—Mn—Al alloy;
preparing a second club head part made of an alloy having a melting point higher than that of the Fe—Mn—Al alloy; and
bonding the first club head part and the second club head part together by high energy welding having an energy density substantially greater than 10⁶ W/mm², thereby causing momentary synchronous melting and secure welding bonding of the first club head part and the second club head part.

2. The welding method as claimed in claim 1, wherein the alloy for the second club head part is selected from a group consisting of stainless steel, carbon steel, low-carbon steel, alloy steel, low-alloy steel, maraging steel, martensite steel, cast iron, structural steel, and W—Fe—Ni alloy.

3. The welding method as claimed in claim 1, wherein the high energy welding is laser welding having an energy density greater than 10⁷ W/mm².

4. The welding method as claimed in claim 1, wherein the high energy welding is electronic beam welding having an energy density greater than 10⁷ W/mm².

5. The welding method as claimed in claim 1, wherein the first club head part is a body of a golf club head.

6. The welding method as claimed in claim 5, wherein the body comprises an assembling opening in a front side thereof for engaging with the second club head part.

7. The welding method as claimed in claim 6, wherein the body comprises a stepped portion extending inward from an inner perimeter delimiting the assembling opening, and wherein the second club head part is engaged with the stepped portion.

8. The welding method as claimed in claim 6, wherein the assembling opening comprises a main engaging lip and a side engaging lip for engaging with the second club head part.

9. The welding method as claimed in claim 1, wherein the first club head part is a striking plate.

10. The welding method as claimed in claim 9, wherein the striking plate comprises a perimeter wall to form a substantially U-shaped structure for improving elastomeric deforming capability.

11. The welding method as claimed in claim 10, wherein the striking plate further comprises an open side, each of the perimeter wall and the open side having an end face engaged with the assembling opening.

12. The welding method as claimed in claim 1, wherein the first club head part is a cover plate.

13. The welding method as claimed in claim 12, wherein the cover plate is one of a crown plate, a sole plate, and a side plate.

14. The welding method as claimed in claim 1, wherein the first club head part is a weight member.

15. The welding method as claimed in claim 1, wherein the second club head part is a body of a golf club head.

16. The welding method as claimed in claim 15, wherein the body comprises an assembling opening in a front side thereof for engaging with the first club head part.

17. The welding method as claimed in claim 16, wherein the body comprises a stepped portion extending inward from an inner perimeter delimiting the assembling opening, and wherein the first club head part is engaged with the stepped portion.

18. The welding method as claimed in claim 16, wherein the assembling opening comprises a main engaging lip and a side engaging lip for engaging with the first club head part.

19. The welding method as claimed in claim 1, wherein the second club head part is a striking plate.

20. The welding method as claimed in claim 19, wherein the striking plate comprises a perimeter wall to form a substantially U-shaped structure for improving elastomeric deforming capability.

21. The welding method as claimed in claim 20, wherein the striking plate further comprises an open side, each of the perimeter wall and the open side having an end face engaged with the assembling opening.

22. The welding method as claimed in claim 1, wherein the second club head part is a cover plate.

23. The welding method as claimed in claim 22, wherein the cover plate is one of a crown plate, a sole plate, and a side plate.

24. The welding method as claimed in claim 1, wherein the second club head part is a weight member.

25. The welding method as claimed in claim 1, wherein a difference in temperature between two melting points of the first club head part and second club head part is greater than 100° C.
